(19) United States
(12) Patent Application Publication
(10) Pub. No.: US 2014/0302822 A1
(43) Pub. Date: Oct. 9, 2014

(54) Terminal Device, Interactive Voice Response Device, Missed Call Reminding System and Method

(71) Applicant: Huawei Technologies Co., Ltd., Shenzhen (CN)

(72) Inventors: Wenwu Ye, Shenzhen (CN); Liang Li, Shenzhen (CN)

(21) Appl. No.: 14/311,052

(22) Filed: Jun. 20, 2014

Related U.S. Application Data
(63) Continuation of application No. PCT/CN2013/073870, filed on Apr. 8, 2013.

(51) Int. Cl. H04W 4/12

(52) U.S. Cl. CPC H04W 4/12
USPC 455/412.2

(57) ABSTRACT

A terminal device, an interactive voice response device, and a missed call reminding system and method are provided that relate to the field of computer and communications technologies. In the embodiments of the present invention, in the interactive voice response device, all user accounts that use a terminal device are bound to the terminal device, and based on an operator's call forwarding service, experience of a missed call reminding service that is previously not accomplishable by the operator is provided for a terminal user, and a missed call can be sent into the terminal device in time when a subscriber identity module card of the user is unavailable, which enables the user to obtain better experience of missed call reminding.

### CROSS-REFERENCE TO RELATED APPLICATIONS

This application is a continuation of International Application No. PCT/CN2013/073870, filed on Apr. 8, 2013, which is hereby incorporated by reference in its entirety.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to the field of computer and communications technologies, and in particular, to a terminal device, an interactive voice response device, and a missed call reminding system and method.

### BACKGROUND

A phone call is a main and very important manner of real-time communication between people nowadays. In this field, various services provided by telecommunication (telecom) operators have basically fulfilled basic requirements of people. Due to importance of a phone call, the telecom operators also provide corresponding auxiliary services for a call that is not answered in time, for example, a missed call, a missed short message reminder/voice message, and the like. A missed call means that a mobile terminal user of an operator fails to receive an incoming call or short message notification (for example, a ringtone) when a device is powered off, a subscriber identity module (SIM) card is damaged or abnormal, the subscriber identity module card is removed, the device is not in a service area, a roaming service is not activated, or in other non-normal service states, and the terminal device has no relevant call record. However, such services have an obvious defect: the services are available only when the user uses the terminal device to register the subscriber identity module card on the network again.

However, with development of terminal technologies, more terminals support dual-card dual-standby or even more cards on one device. The probability that one of the cards is unavailable (temporarily unavailable, for example, when the card is removed) increases significantly. In addition, the industry has been exploring service products related to a virtual subscriber identity module card (primarily applicable to mobile data services). Limited by current terminal technologies, such products also cause an original entity subscriber identity module card of the operator to be unable to provide services normally in a time period. However, in this case, data channels of most users are still available in fact, or a data network is accessed by using wireless fidelity (WIFI) or using a local subscriber identity module card in a roaming area. However, none of the solutions in the prior art can notify the user of a missed call in time.

### SUMMARY

Embodiments of the present invention provide a terminal device, an interactive voice response device, and a missed call reminding system and method to solve a problem in the prior art that a missed call to a user account cannot be sent to the terminal device in time in a case that the user account is unavailable but the terminal device is available.

To solve the foregoing technical problem, the embodiments of the present invention disclose the following technical solutions:

A first aspect provides a terminal device, including: an account binding unit configured to send an account binding request to an interactive voice response device, where the account binding request is a request for binding a user account to the terminal device, so as to enable the interactive voice response device to record information about the binding between the user account and the terminal device; a forwarding setting unit configured to bind configuration information for missed call forwarding of the user account onto a preset service number of the interactive voice response device; and a missed call receiving unit configured to receive a missed call reminder sent by the interactive voice response device according to the information about the binding, where the missed call reminder is a reminder of a missed call to the user account.

In a first possible implementation manner of the first aspect, the information about the binding between the user account and the terminal device includes mapping relationships between all user accounts that use the terminal device and the terminal device identifier.

In a second possible implementation manner of the first aspect, the missed call receiving unit includes a user identity recognizing unit configured to receive missed call reminders that are sent by the interactive voice response device to other user accounts except the called user account in the terminal device by using a short message gateway.

In a third possible implementation manner of the first aspect, the information about the binding between the user account and the terminal device further includes at least either of a mapping relationship between the terminal device identifier and an instant messaging application and a mapping relationship between the terminal device identifier and a push service.

In a fourth possible implementation manner of the first aspect, the missed call receiving unit includes an instant messaging application unit configured to receive a missed call reminder that is sent by the interactive voice response device to the terminal device by using an instant messaging server.

In a fifth possible implementation manner of the first aspect, the missed call receiving unit includes a push application unit configured to receive a missed call reminder that is sent by the interactive voice response device to the terminal device by using a push server.

In a sixth possible implementation manner of the first aspect, the forwarding setting unit binds the configuration information for missed call forwarding of the user account onto a preset service number of the interactive voice response device by dialing a specific service of an operator.

A second aspect provides an interactive voice response device, including: an account mapping unit configured to record information about binding between a user account and a terminal device, and further configured to obtain, according to the information about the binding, a terminal device identifier bound to a called user account; and a message sending unit configured to send call information as a missed call reminder to a terminal device corresponding to the terminal device identifier.

In a first possible implementation manner of the second aspect, the information about the binding between the user account and the terminal device includes mapping relationships between all user accounts that use the terminal device and the terminal device identifier.

In a second possible implementation manner of the second aspect, the message sending unit includes a short message gateway interface unit configured to use the short message gateway to send the call information to other user accounts bound to the terminal device except the called account in the terminal device.

In a third possible implementation manner of the second aspect, the information about the binding between the user account and the terminal device further includes at least either of a mapping relationship between the terminal device and an instant messaging application and a mapping relationship between the terminal device and a push service.

In a fourth possible implementation manner of the second aspect, the message sending unit includes an instant messaging interface unit configured to use an instant messaging server to send the call information to an instant messaging application in the terminal device.

In a fifth possible implementation manner of the second aspect, the message sending unit includes a push service interface unit configured to use a push server to send the call information to a push application in the terminal device.

In a sixth possible implementation manner of the second aspect, the interactive voice response device further includes a voice recording unit and a voice converting unit, where the voice recording unit is configured to record a voice message that is left in time of calling; the voice converting unit is configured to convert the voice message into text information; and the message sending unit sends at least either of the voice message and the text information together with the call information as a missed call reminder to the terminal device bound to the called user account.

A third aspect provides a missed call reminding system, including a service server, a terminal device described in any one of the foregoing items and an interactive voice response device described in any one of the foregoing items, where the terminal device and the interactive voice response device are connected to the service server over an operator network.

In a first possible implementation manner of the third aspect, the service server includes a short message gateway, an instant messaging server, and a push server.

A fourth aspect provides a missed call reminding method, including steps: sending, by a terminal device, an account binding request to an interactive voice response device, where the account binding request is a request for binding a user account to the terminal device, so as to enable the interactive voice response device to record information about the binding between the user account and the terminal device; binding, by the terminal device, configuration information for missed call forwarding of the user account onto a preset service number of the interactive voice response device; and receiving, by the terminal device, a missed call reminder sent by the interactive voice response device according to the information about the binding, where the missed call reminder is a reminder of a missed call to the user account.

In a first possible implementation manner of the fourth aspect, the information about the binding between the user account and the terminal device includes mapping relationships between all user accounts that use the terminal device and the terminal device identifier.

In a second possible implementation manner of the fourth aspect, the receiving, by the terminal device, a missed call reminder sent by the interactive voice response device according to the information about the binding, where the missed call reminder is a reminder of a missed call to the user account, specifically includes: receiving missed call reminders that are sent by the interactive voice response device to other user accounts except the called user account in the terminal device by using a short message gateway.

In a third possible implementation manner of the fourth aspect, the information about the binding between the user account and the terminal device further includes at least either of a mapping relationship between the terminal device identifier and an instant messaging application and a mapping relationship between the terminal device identifier and a push service.

In a fourth possible implementation manner of the fourth aspect, the receiving, by the terminal device, a missed call reminder sent by the interactive voice response device according to the information about the binding, where the missed call reminder is a reminder of a missed call to the user account, specifically includes receiving, by an instant messaging application in the terminal device, a missed call reminder that is sent by the interactive voice response device to the terminal device by using an instant messaging server.

In a fifth possible implementation manner of the fourth aspect, the receiving, by the terminal device, a missed call reminder sent by the interactive voice response device according to the information about the binding, where the missed call reminder is a reminder of a missed call to the user account, specifically includes receiving, by a push application in the terminal device, a missed call reminder that is sent by the interactive voice response device to the terminal device by using a push server.

In a sixth possible implementation manner of the fourth aspect, the terminal device binds the configuration information for missed call forwarding of the called user account onto a preset service number of the interactive voice response device by dialing a specific service of an operator.

A fifth aspect provides a missed call reminding method, including steps: recording, by an interactive voice response device, information about binding between a user account and a terminal device, and obtaining, according to the information about the binding, a terminal device identifier bound to a called user account; and sending, by the interactive voice response device, call information as a missed call reminder to a terminal device corresponding to the terminal device identifier.

In a first possible implementation manner of the fifth aspect, the information about the binding between the user account and the terminal device includes mapping relationships between all user accounts that use the terminal device and the terminal device identifier.

In a second possible implementation manner of the fifth aspect, the sending, by the interactive voice response device, call information as a missed call reminder to a terminal device corresponding to the terminal device identifier, specifically includes using a short message gateway to send the call information to other user accounts bound to the terminal device except the called account in the terminal device.

In a third possible implementation manner of the fifth aspect, the information about the binding between the user account and the terminal device further includes at least either of a mapping relationship between the terminal device and an instant messaging application and a mapping relationship between the terminal device and a push service.

In a fourth possible implementation manner of the fifth aspect, the sending, by the interactive voice response device, call information as a missed call reminder to a terminal device corresponding to the terminal device identifier, specifically includes using an instant messaging server to send the call information to an instant messaging application in the terminal device.

In a fifth possible implementation manner of the fifth aspect, the sending, by the interactive voice response device, call information as a missed call reminder to a terminal device corresponding to the terminal device identifier, specifically includes using a push server to send the call information to a push application in the terminal device.

In a sixth possible implementation manner of the fifth aspect, before the sending, by the interactive voice response device, call information as a missed call reminder to a terminal device bound to the called user account, the method further includes: recording a voice message that is left in time of calling, and converting the voice message into text information; and, in time of sending, sending at least either of the voice message and the text information together with the call information as a missed call reminder to the terminal device bound to the called user account.

With the terminal device, the interactive voice response device, and the missed call reminding system and method provided in the embodiments of the present invention, in the interactive voice response device, all user accounts that use the terminal device are bound to the terminal device, and, based on an operator's call forwarding service, experience of a missed call reminding service that is previously not accomplishable by the operator is provided by the interactive voice response device for a terminal user when a user account is unavailable but the terminal device is still available (for example, a corresponding subscriber identity module card is removed), and the missed call to a user account can be sent to the terminal device in time.

### BRIEF DESCRIPTION OF THE DRAWINGS

To describe the technical solutions in the embodiments of the present invention more clearly, the following briefly introduces the accompanying drawings required for describing the embodiments. The accompanying drawings in the following description show some embodiments of the present invention, and a person of ordinary skill in the art may still derive other drawings from these accompanying drawings without creative efforts.

FIG. 1 is a schematic structural diagram of a terminal device according to the present invention;

FIG. 2 is a schematic structural diagram of an interactive voice response device according to the present invention;

FIG. 3 is a schematic structural diagram of a missed call reminding system according to the present invention;

FIG. 4 is a flowchart for a terminal device side in a missed call reminding method according to the present invention;

FIG. 5 is a flowchart for an interactive voice response device side in a missed call reminding method according to the present invention;

FIG. 6 is a specific implementation flowchart of a missed call reminding method according to the present invention;

FIG. 7 is another specific implementation flowchart of a missed call reminding method according to the present invention; and

FIG. 8 is a schematic structural diagram of hardware of an interactive voice response device according to the present invention.

### DETAILED DESCRIPTION

To make the objectives, technical solutions, and advantages of the embodiments of the present invention clearer, the following clearly describes the technical solutions in the embodiments of the present invention with reference to the accompanying drawings in the embodiments of the present invention. The described embodiments are a part rather than all of the embodiments of the present invention. All other embodiments obtained by a person of ordinary skill in the art based on the embodiments of the present invention without creative efforts shall fall within the protection scope of the present invention.

In the embodiments of the present invention, terminal devices include but are not limited to mobile communications devices such as a mobile phone, a personal digital assistant (PDA), a tablet, and a portable device (such as a portable computer), which are not limited by the embodiments of the present invention.

The following describes specific implementation manners of the present invention in more detail with reference to accompanying drawings and embodiments. The following embodiments are used to describe the present invention but are not intended to limit the scope of the present invention.

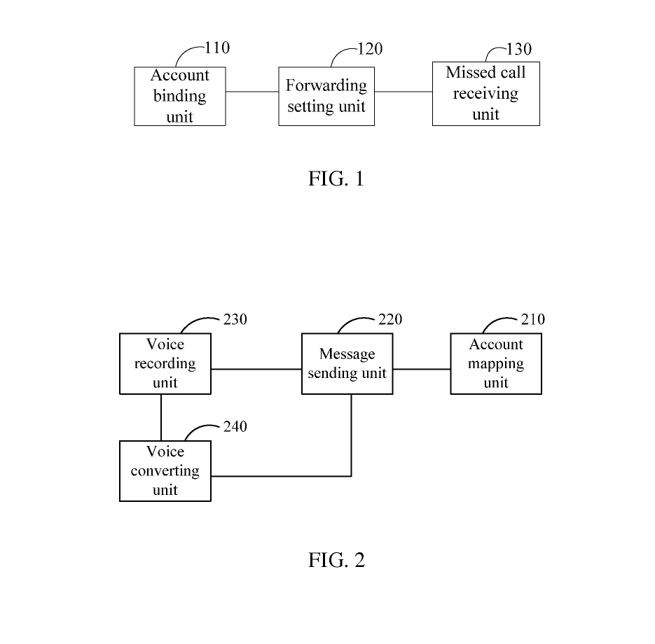

Embodiment 1 of the present invention provides a terminal device. As shown in FIG. 1, the terminal device includes an account binding unit 110, a forwarding setting unit 120, and a missed call receiving unit 130. The account binding unit 110 is configured to send an account binding request to an interactive voice response (IVR) device, where the account binding request is a request for binding a user account to the terminal device, so as to enable the interactive voice response device to record information about the binding between the user account and the terminal device. The forwarding setting unit 120 is configured to bind configuration information for missed call forwarding of the user account onto a preset service number of the interactive voice response device. The configuration information is information about a corresponding call forwarding service registered by the user account with an operator. After the binding is performed, when the user number cannot be called, the call is forwarded to the service number, and then the interactive voice response device performs subsequent forwarding processing. The missed call receiving unit 130 is configured to receive a missed call reminder sent by the interactive voice response device according to the information about the binding, where the missed call reminder is a reminder of a missed call to the user account.

The terminal device may be a device such as a smartphone and a tablet, and the terminal device is uniquely identified by a device identifier (for example, an International Mobile Equipment Identity (IMEI)). The user account is generally a mobile phone number, that is, a mobile station integrated services digital network number (MSISDN). One mobile phone may include multiple subscriber identity module cards, that is, may have multiple user accounts. The information about the binding between the user account and the terminal device includes mapping relationships between all user accounts that use the terminal device and a terminal device identifier. When a user handles a basic call service with the operator, the user account is bound to the subscriber identity module card beforehand. Therefore, the information about the binding between the user account and the terminal device further implicitly includes a mapping relationship between the subscriber identity module card number corresponding to the user account and the terminal device identifier. In time of requesting binding, the interactive voice response device is requested to bind all user accounts that use the terminal device and the subscriber identity module card number to the terminal device identifier, that is, enable the interactive voice response device to record the mapping relationships, where the mapping relationships may be stored in a manner of a relationship mapping table in the interactive voice response device.

When necessary (for example, before roaming), the user uses the forwarding setting unit 120 to dial a specific service of an operator (for example, China Telecom: dial *72+phone number to perform call forwarding unconditional; dial *720 to cancel; dial *90+phone number to perform call forwarding on busy; dial *900 to cancel; dial *92+phone number to perform call forwarding on no reply; dial *920 to cancel; and dial *730 to cancel all forwarding) so that the forwarding configuration information of calls that call the user account is bound onto the corresponding service number of the interactive voice response device.

The missed call receiving unit 130 may be a user identity recognizing unit. After the forwarding is set, the user identity recognizing unit receives missed call reminders that are sent by the interactive voice response device to other user accounts except the called user account in the terminal device by using a short message gateway. In a case that a subscriber identity module card on the terminal device is unavailable (for example, no roaming service is activated), when a first user account corresponding to the subscriber identity module card is called, the call is forwarded to the interactive voice response device. According to the mapping relationship in the information about the binding between the user account and the terminal device, the interactive voice response device finds a second user account corresponding to another subscriber identity module card bound to the terminal, and sends call information (generally including information such as call time and a caller user account) as a missed call reminder to the terminal device by using a short message gateway on an operator network side and using the second user account, so as to remind the user in time. The missed call receiving unit 130 of the terminal device may be a user identity recognizing unit, and the user identity recognizing unit receives the missed call reminder that is sent by using the second user account and related to the first user account.

In this embodiment, all user accounts that use the terminal device are bound to the terminal device beforehand in the interactive voice response device. When one of the user accounts is unavailable, the missed call reminder of the unavailable user account is sent to the terminal device by using another user account bound to the terminal device, so that the missed call to the unavailable user account can be sent to the terminal device in time.

When the terminal device provides only one subscriber identity module card slot or the subscriber identity modules in multiple slots are all unavailable, the interactive voice response device is unable to send the missed call information to the terminal device in time, and the user identity recognizing unit is unable to receive the missed call information of a certain user account from the interactive voice response device in time.

Further, the information about the binding between the user account and the terminal device further includes at least either of a mapping relationship between the terminal device and an instant messaging (IM) application installed in the terminal device and a mapping relationship between the terminal device and a push service installed in the terminal device, which may be stored in a manner of a relationship mapping table in the interactive voice response device. For example, the mapping table may include: mapping relationships between all user accounts that use the terminal device and the terminal device identifier, and a mapping relationship between the corresponding subscriber identity module card number of the user account and the terminal device identifier, a mapping relationship between the terminal device identifier and the instant messaging application, and a mapping relationship between the terminal device identifier and the push service. When the terminal device provides only one subscriber identity module slot or the subscriber identity modules in multiple slots are all unavailable, the interactive voice response device may find the instant messaging application or the push application in the terminal device corresponding to the called user account according to the mapping relationship between the terminal device identifier and the instant messaging application or the mapping relationship between the terminal device identifier and the push service, and send a missed call reminder to the terminal device by using the instant messaging application or the push application.

The missed call receiving unit 130 may also be an instant messaging application unit configured to receive the missed call reminder that is sent by the interactive voice response device to the terminal device by using an instant messaging server on the operator network side.

The missed call receiving unit 130 may also be a push application unit configured to receive the missed call reminder that is sent by the interactive voice response device to the terminal device by using a push server on the operator network side. For example, when the instant messaging application is offline, the missed call reminder that is sent by the interactive voice response device to the terminal device by using the push server on the operator network side is received. Of course, when the instant messaging application and the push application are online simultaneously, either of them may be selected to send the missed call reminder to the terminal device.

The terminal device in this embodiment enables the user to receive the missed call reminder in time, which improves user experience significantly.

Embodiment 2 of the present invention provides an interactive voice response device. As shown in FIG. 2, a structure of the interactive voice response device in the present invention includes an account mapping unit 210 and a message sending unit 220.

The account mapping unit 210 is configured to record information about binding between a user account and a terminal device after receiving an account binding request sent by the terminal device, and, in time of call forwarding, obtain, according to the information about the binding, a terminal device identifier bound to a called user account. The information about the binding between the user account and the terminal device includes mapping relationships between all user accounts that use the terminal device and a terminal device identifier, and also implicitly includes mapping relationships between corresponding subscriber identity module card numbers of all the user accounts that use the terminal device and the terminal device identifier.

The message sending unit 220 is configured to send call information as a missed call reminder to a terminal device corresponding to the terminal device identifier. In this embodiment, the message sending unit 220 may be a short message gateway interface unit configured to use a short message gateway on an operator network side to send the call information to other bound user accounts except the called account in the terminal device. That is, another user account (such as a mobile phone number of another subscriber identity module card) stored in the account mapping unit 210 is used as a user identifier for interconnecting with the short message gateway, and a missed call reminder is sent to the another user account (that is, the another subscriber identity module card) bound to the terminal device corresponding to the called user account.

When the terminal device provides only one subscriber identity module card slot or the subscriber identity modules in multiple slots are all unavailable, the interactive voice response device is unable to send the missed call information to the terminal device in time, and the user identity recognizing unit is unable to receive the missed call information of a certain user account from the interactive voice response device in time.

Further, the information about the binding between the user account and the terminal device further includes either or both of a mapping relationship between the terminal device and an instant messaging application installed in the terminal device and a mapping relationship between the terminal device and a push service installed in the terminal device. When the terminal device provides only one subscriber identity module slot or the subscriber identity modules in multiple slots are all unavailable, the interactive voice response device may find the instant messaging application and the push application in the terminal device corresponding to the called user account according to the mapping relationships, and send a missed call reminder to the terminal device by using the instant messaging application or the push application.

The message sending unit 220 may also be an instant messaging interface unit configured to use an instant messaging server on the operator network side to send the call information to the instant messaging application in the terminal device.

The message sending unit 220 may also be a push service interface unit configured to use a push server on the operator network side to send the call information to the terminal device. For example, when the instant messaging application is offline, the push service interface unit uses the push server on the operator network side to send a missed call reminder to the terminal device.

To further improve user experience, the interactive voice response device generally further includes a voice recording unit 230 and a voice converting unit 240. The voice recording unit 230 is configured to record a voice message that is left in time of calling; and the voice converting unit 240 is configured to convert the voice message into text information. The message sending unit 220 sends both or either of the voice message and the text information together with the call information as a missed call reminder to the terminal device bound to the called user account. That is, in time of sending the missed call reminder, the voice message may be sent directly, or only the text information is sent, or both the voice message and the text information may be sent simultaneously.

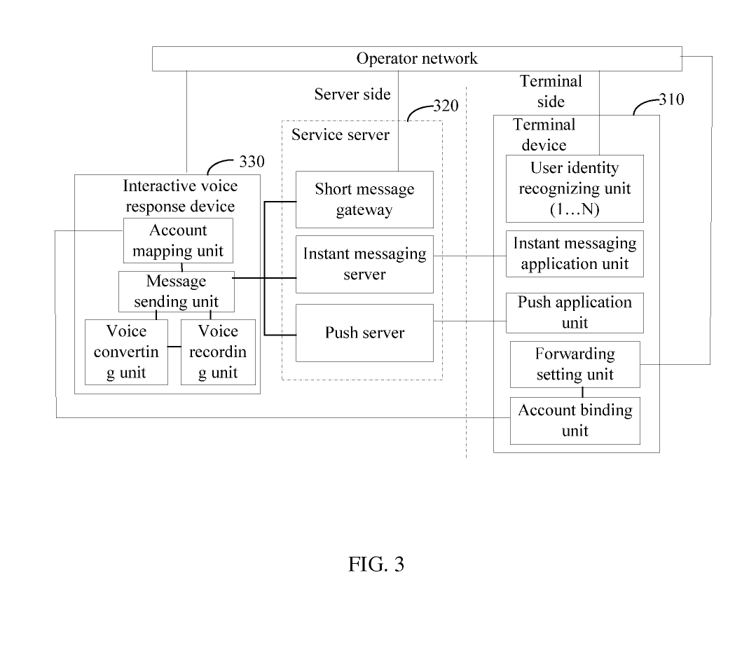

Embodiment 3 of the present invention provides a missed call reminding system. As shown in FIG. 3, the missed call reminding system includes a terminal device 310 located on a terminal side, and a service server 320 and an interactive voice response device 330 that are located on a service side. The terminal device 310 and the interactive voice response device 330 are connected to the service server 320 over an operator network. In this embodiment, the service server 320 may be a server that provides multiple service functions, and may also include multiple servers of different service functions, for example, a short message gateway, an instant messaging server, and a push server. The terminal device 310 is a terminal device in Embodiment 1, and includes an account binding unit, a forwarding setting unit, an instant messaging application unit, a push application unit, and multiple user identity recognizing units. The interactive voice response device 330 is the interactive voice response device in Embodiment 2, and includes an account mapping unit, a voice recording unit, a voice converting unit, and a message sending unit.

The account binding unit of the terminal device 310 sends an account binding request to the interactive voice response device 330, where the account binding request is a request for binding a user account to a terminal device. After receiving the request, the account mapping unit of the interactive voice response device 330 records information about the binding between the user account and the terminal device. By dialing a specific service number of an operator, the forwarding setting unit 120 of the terminal device 310 sets forwarding of calls to the user account so that the calls are forwarded to a preset service number corresponding to the interactive voice response device, that is, the calls are forwarded to the interactive voice response device 330.

When the interactive voice response device 330 receives a forwarded call sent by the operator network, the voice recording unit records a voice message. According to the recorded information about the binding between the user account and the terminal device, the account mapping unit obtains a terminal device identifier bound to the called user account. The voice converting unit may convert the voice message into text information as required. The message sending unit sends the voice message and/or text information as a missed call reminder to the terminal device bound to the called user account, and specifically, by using a short message gateway on the operator network side or an instant messaging server or a push server, sends the missed call reminder to the terminal device bound to the called user account.

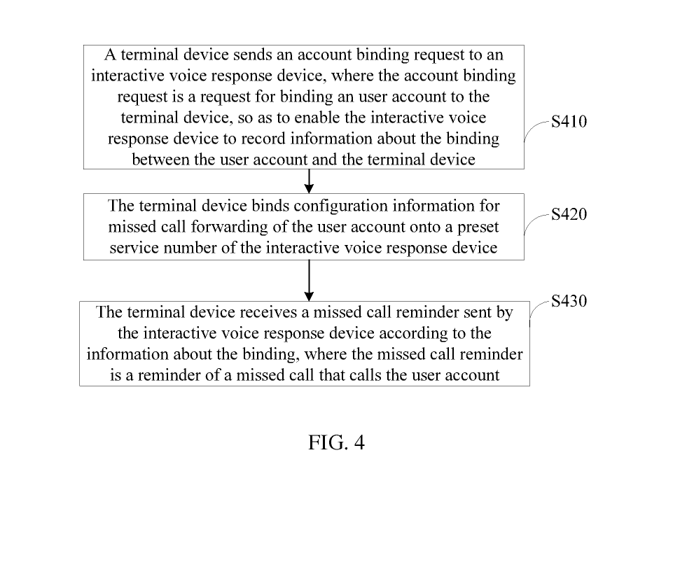

Embodiment 4 of the present invention provides a missed call reminding method. As shown in FIG. 4, a specific procedure includes:

Step S410: A terminal device sends an account binding request to an interactive voice response device, where the account binding request is a request for binding a user account to the terminal device, so as to enable the interactive voice response device to record information about the binding between the user account and the terminal device.

Step S420: The terminal device binds configuration information for missed call forwarding of the user account onto a preset service number of the interactive voice response device.

Step S430: The terminal device receives a missed call reminder sent by the interactive voice response device according to the information about the binding, where the missed call reminder is a reminder of a missed call to the user account.

The information about the binding between the user account and the terminal device includes mapping relationships between all user accounts that use the terminal device and a terminal device identifier, and also implicitly includes mapping relationships between corresponding subscriber identity module card numbers of all the user accounts that use the terminal device and the terminal device identifier. In step S430, a specific manner of the receiving, by the terminal device, a missed call reminder sent by the interactive voice response device according to the information about the binding, where the missed call reminder is a reminder of a missed call to the user account, may be: receiving missed call reminders that are sent by the interactive voice response device to other user accounts bound to the terminal device except the called user account in the terminal device by using a short message gateway on an operator network side.

To further improve user experience, when all subscriber identity module cards in the terminal device are unavailable, the terminal device of the user can also receive a missed call reminder in time, and the information about the binding between the user account and the terminal device further includes at least either of a mapping relationship between the terminal device identifier and an instant messaging application and a mapping relationship between the terminal device identifier and a push service.

In step S430, a specific manner of the receiving, by the terminal device, a missed call reminder sent by the interactive voice response device according to the information about the binding, where the missed call reminder is a reminder of a missed call to the user account, may be receiving, by an instant messaging application in the terminal device, a missed call reminder that is sent by the interactive voice response device to the terminal device by using an instant messaging server on an operator network side.

In step S430, a specific manner of the receiving, by the terminal device, a missed call reminder sent by the interactive voice response device according to the information about the binding, where the missed call reminder is a reminder of a missed call to the user account, may also be receiving, by a push application in the terminal device, a missed call reminder that is sent by the interactive voice response device to the terminal device by using a push server on the operator network side.

In this embodiment, the terminal device binds the configuration information for missed call forwarding of the called user account onto a preset service number of the interactive voice response device by dialing a specific service of an operator.

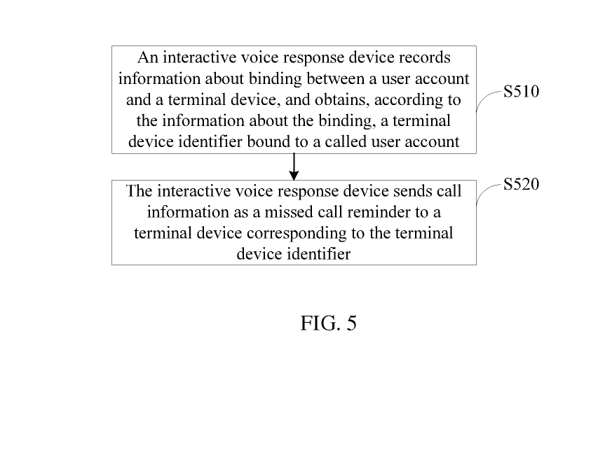

Embodiment 5 of the present invention provides a missed call reminding method. As shown in FIG. 5, the method includes:

Step S510: An interactive voice response device receives an account binding request sent by a terminal device, and records information about binding between a user account and a terminal device, and obtains, according to the information about the binding, a terminal device identifier bound to a called user account.

Step S520: The interactive voice response device sends call information as a missed call reminder to a terminal device corresponding to the terminal device identifier.

The information about the binding between the user account and the terminal device includes mapping relationships between all user accounts that use the terminal device and a terminal device identifier, and also implicitly includes mapping relationships between corresponding subscriber identity module card numbers of all the user accounts that use the terminal device and the terminal device identifier.

In step S520, a specific manner of the sending, by the interactive voice response device, call information as a missed call reminder to a terminal device corresponding to the terminal device identifier, may be using a short message gateway on an operator network side to send the call information to other user accounts bound to the terminal device except the called account in the terminal device.

To further improve user experience, so that the interactive voice response device can also send a missed call reminder to the terminal device in time when all subscriber identity module cards in the terminal device are unavailable, the information about the binding between the user account and the terminal device further includes at least either of a mapping relationship between the terminal device and an instant messaging application installed in the terminal device and a mapping relationship between the terminal device and a reminder service installed in the terminal device.

In step S520, a specific manner of the sending, by the interactive voice response device, call information as a missed call reminder to a terminal device corresponding to the terminal device identifier, may be using an instant messaging server on the operator network side to send the call information to an instant messaging application in the terminal device.

In step S520, a specific manner of the sending, by the interactive voice response device, call information as a missed call reminder to a terminal device corresponding to the terminal device identifier, may also be using a push server on the operator network side to send the call information to a push application in the terminal device.

Before the sending, by the interactive voice response device, call information as a missed call reminder to a terminal device bound to the called user account, the method further includes: recording a voice message that is left in time of calling, and converting the voice message into text information; and, in time of sending, sending both or either of the voice message and the text information together with the call information at this time as a missed call reminder to the terminal device bound to the called user account.

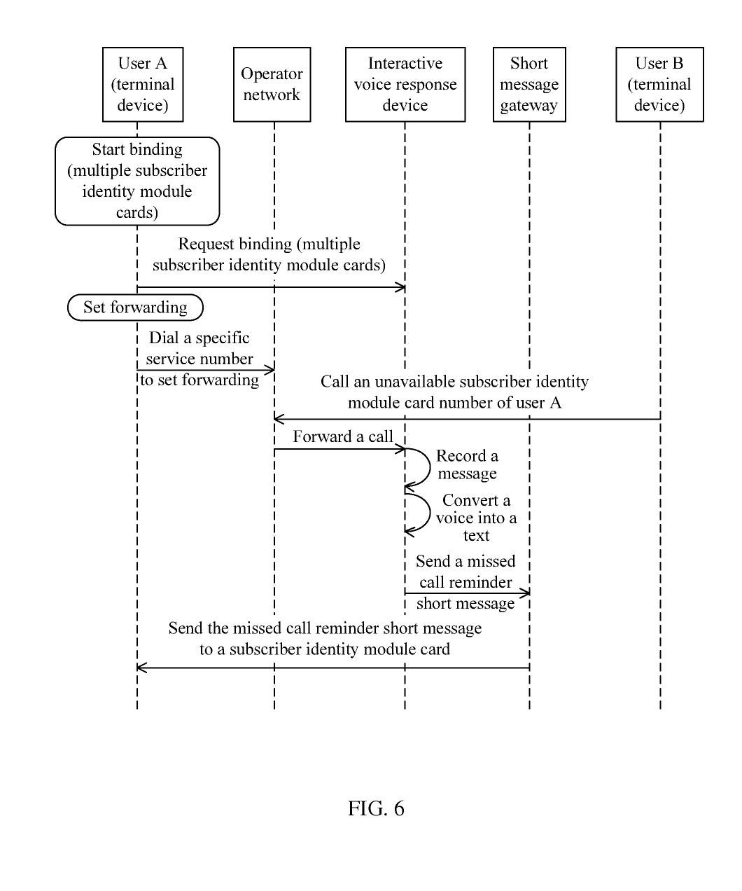

The present invention is further described by using the following two scenarios, as shown in FIG. 6.

User A uses an account binding unit on a terminal to perform user account binding (bind multiple user accounts to one terminal device identifier).

The account binding unit is linked to an interactive voice response device to complete the binding between the user account and the device.

User A uses a forwarding setting unit on the terminal to set call forwarding. The forwarding setting unit dials a specific service number of an operator to set forwarding of a call to a service number corresponding to the interactive voice response device.

In time of call forwarding, user B dials a mobile phone of user A, and, according to the call forwarding setting of user A, the operator forwards the call from user B to the interactive voice response device, and a voice recording unit of the interactive voice response device records a voice message of user B.

By querying the stored information about the binding between the user account and the terminal device, an account mapping unit of the interactive voice response device obtains an identity of user A and corresponding terminal mapping information.

A message sending unit of the interactive voice response device selects a channel for sending a reminder to the user's mobile phone. Specifically, a voice converting unit of the interactive voice response device converts the user message into text, and the message sending unit of the interactive voice response device uses a short message to send the message converted into the text to another subscriber identity module card bound to user A.

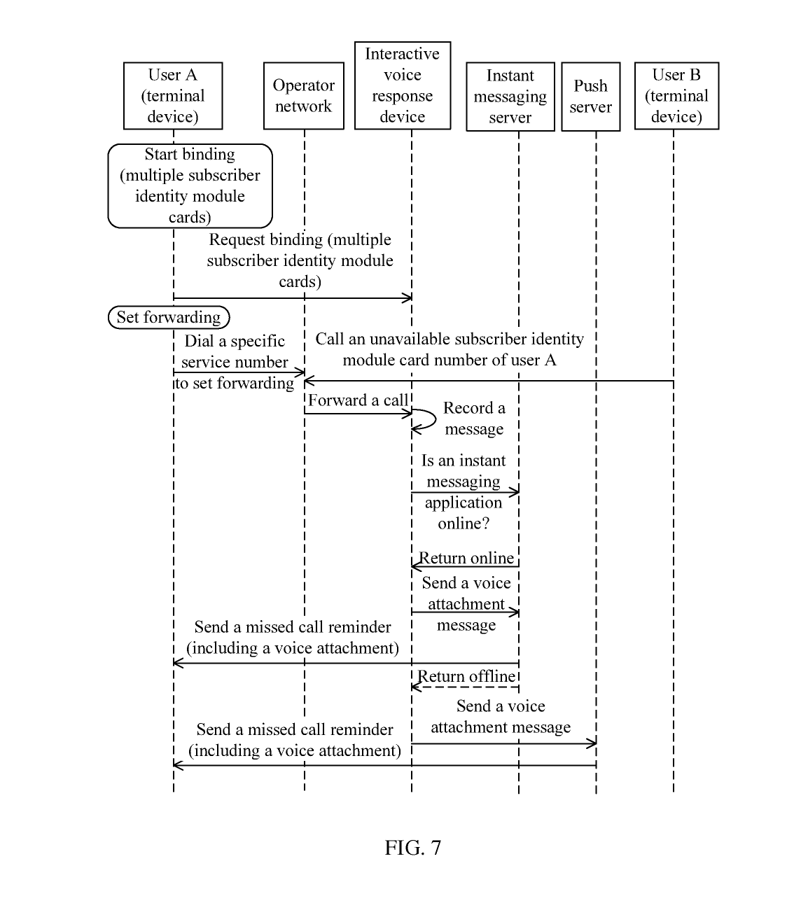

As shown in FIG. 7, another scenario shows another manner of missed call reminding when an instant messaging application and a push application exist on the user's terminal device and the operator can provide an instant messaging service and a push service correspondingly.

User A uses an account binding unit on a terminal to perform user account binding (bind multiple user accounts to one terminal device identifier).

The account binding unit is linked to an interactive voice response device to complete the binding between the user account and the device.

User A uses a forwarding setting unit on the terminal to set call forwarding. The forwarding setting unit dials a specific service number of an operator to set forwarding of a call to a service number corresponding to the interactive voice response device.

In time of call forwarding, user B dials a mobile phone of user A, and, according to the call forwarding setting of user A, the operator forwards the call from user B to the interactive voice response device, and a voice recording unit of the interactive voice response device records a voice message of user B.

By querying the information about the binding between the user account and the terminal device, an account mapping unit of the interactive voice response device obtains an identity of user A and corresponding terminal mapping information.

A message sending unit of the interactive voice response device selects a channel for sending a reminder to the user's mobile phone. The message sending unit of the interactive voice response device selects a sending manner according to an online state of the instant messaging application of the terminal of user A:

1. If an instant messaging client of user A is online, a voice file of the message is used as a multimedia attachment, and an instant messaging message that includes a missed call reminder is sent to the instant messaging client of the user.

2. If the instant messaging client of user A is offline, a push message of a missed call reminder is sent to the user by using a push service, and the missed call information is sent to the user terminal.

Of course, when the instant messaging client and the push application client are online simultaneously, either of them may be selected to send the missed call reminder to the terminal device.

This method enables the user with the terminal to obtain the missed call reminder in time when a certain subscriber identity module card on a single-card, dual-card, or multi-card mobile phone terminal is removed and unavailable and when an entity subscriber identity module card is unavailable (a data channel is available) in a mobile phone with a virtual card in a roaming state.

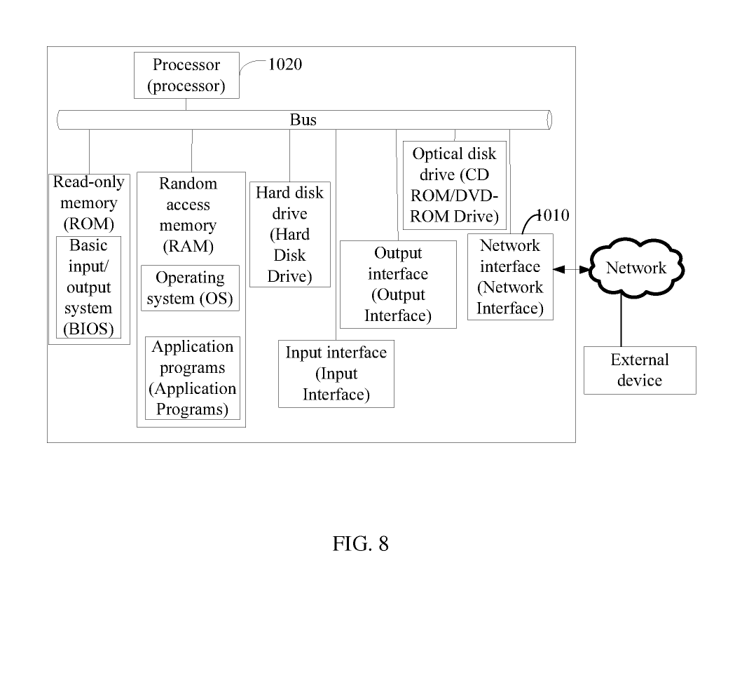

As shown in FIG. 8, similar to an existing computer, the interactive voice response device described in the present invention exchanges information with an external device through a network interface 1010, for example, receives an account binding request sent by the terminal device, sends information to a network-side service server, and the like; the interactive voice response device uses a processor 1020 to process information from the external device, for example, creates a relationship mapping table between a corresponding user account and a terminal device according to the account binding request sent by the terminal device, and obtains a bound terminal device identifier from the relationship mapping table according to the called user account when the call is forwarded.

A person of ordinary skill in the art understands that each aspect of the present invention or any possible implementation manner of each aspect may be implemented in the form of a system, a method, or a computer program product. Therefore, each aspect of the present invention or any possible implementation manner of each aspect may take the form of an all hardware embodiment, the form of an all software embodiment (including firmware, residing software, and on the like), or the form of a combination of software and hardware embodiments, which are uniformly referred to as a “circuit”, a “module” or a “system” herein. Furthermore, each aspect of the present invention or any possible implementation manner of each aspect may take the form of a computer program product, where the computer program product refers to computer-readable program codes stored on a computer-readable medium.

The computer-readable medium may be a computer-readable signal medium or a computer-readable storage medium. The computer-readable storage medium includes but is not limited to electronic, magnetic, optical, electromagnetic, infrared, or semiconductor systems, devices or apparatuses, or any appropriate combination thereof, such as a random-access memory (RAM), a read-only memory (ROM), an erasable programmable read-only memory (EPROM or flash memory), an optical fiber, and a portable read-only memory (for example, a compact disc read-only memory (CD-ROM)).

A processor in the computer reads computer-readable program codes stored in the computer-readable medium, so that the processor can perform function actions specified in each step in the flowchart or in a combination of the steps, and an apparatus for performing function actions specified in each block of the block diagram or in a combination of the blocks can be generated.

The computer-readable program codes may be fully executed on a computer of a user, or partly executed on the computer of the user, or executed as a separate software package, or partly executed on the computer of the user and partly executed on a remote computer, or fully executed on a remote computer or server. It should also be noted that in some alternative implementation solutions, the steps in the flowchart or the functions specified in each block of the block diagram may occur in a different sequence other than that specified in the diagram. For example, depending on the functions involved, two steps shown successively or two blocks may be actually executed almost at the same time, or the blocks may sometimes be executed in a reverse sequence.

A person skilled in the art may make modifications and variations to the invention without departing from the spirit and scope of the invention. In this way, the invention is intended to cover the modifications and variations provided that they fall within the scope of protection defined by the following claims or their equivalents.

### INDUSTRIAL APPLICABILITY

The present invention discloses a terminal device, an interactive voice response device, and a missed call reminding system and method, and relates to the field of computer and communications technologies. In the embodiments of the present invention, all user accounts that use a terminal device in an interactive voice response device are bound to the terminal device, and, based on an operator's call forwarding service, experience of a missed call reminding service that is previously not accomplishable by the operator is provided for a terminal user, and missed calls can be sent to the terminal device in time when a certain subscriber identity module card of the user is unavailable, which enables the user to obtain better experience of missed call reminding. Therefore, the present invention is industrially applicable.

What is claimed is:

1. A terminal device, comprising:
an account binding unit configured to send an account binding request to an interactive voice response device, wherein the account binding request is a request for binding a user account to the terminal device to enable the interactive voice response device to record information about the binding between the user account and the terminal device;
a forwarding setting unit configured to bind configuration information for missed call forwarding of the user account onto a preset service number of the interactive voice response device; and
a missed call receiving unit configured to receive a missed call reminder sent by the interactive voice response device according to the information about the binding, wherein the missed call reminder is a reminder of a missed call to the user account.

2. The terminal device according to claim 1, wherein the information about the binding between the user account and the terminal device comprises mapping relationships between all user accounts that use the terminal device and a terminal device identifier.

3. The terminal device according to claim 2, wherein the missed call receiving unit comprises a user identity recognizing unit configured to receive missed call reminders that are sent by the interactive voice response device to other user accounts except the called user account in the terminal device by using a short message gateway.

4. The terminal device according to claim 2, wherein the information about the binding between the user account and the terminal device further comprises at least either of a mapping relationship between the terminal device identifier and an instant messaging application and a mapping relationship between the terminal device identifier and a push service, wherein the missed call receiving unit comprises an instant messaging application unit configured to receive a missed call reminder that is sent by the interactive voice response device to the terminal device by using an instant messaging server, or wherein the missed call receiving unit comprises a push application unit configured to receive a missed call reminder that is sent by the interactive voice response device to the terminal device by using a push server.

5. The terminal device according to claim 1, wherein the forwarding setting unit binds the configuration information for missed call forwarding of the user account onto a preset service number of the interactive voice response device by dialing a specific service of an operator.

6. An interactive voice response device, comprising:
an account mapping unit configured to record information about binding between a user account and a terminal device, and further configured to obtain, according to the information about the binding, a terminal device identifier bound to a called user account; and
a message sending unit configured to send call information as a missed call reminder to a terminal device corresponding to the terminal device identifier.

7. The interactive voice response device according to claim 6, wherein the information about the binding between the user account and the terminal device comprises mapping relationships between all user accounts that use the terminal device and the terminal device identifier.

8. The interactive voice response device according to claim 7, wherein the message sending unit comprises a short message gateway interface unit configured to use the short message gateway to send the call information to other user accounts bound to the terminal device except the called account in the terminal device.

9. The interactive voice response device according to claim 7, wherein the information about the binding between the user account and the terminal device further comprises at least either of a mapping relationship between the terminal device and an instant messaging application and a mapping relationship between the terminal device and a push service, wherein the message sending unit comprises an instant messaging interface unit configured to use an instant messaging server to send the call information to an instant messaging application in the terminal device, or wherein the message sending unit comprises a push service interface unit configured to use a push server to send the call information to a push application in the terminal device.

10. The interactive voice response device according to claim 6, wherein the interactive voice response device further comprises a voice recording unit and a voice converting unit, wherein the voice recording unit is configured to record a voice message that is left in time of calling, wherein the voice converting unit is configured to convert the voice message into text information, and wherein the message sending unit sends at least either of the voice message and the text information together with the call information as a missed call reminder to the terminal device bound to the called user account.

11. A missed call reminding system, comprising:
a service server;
a terminal device;
an interactive voice response device, wherein the terminal device and the interactive voice response device are connected to the service server over an operator network, wherein the terminal device comprises an account binding unit configured to send an account binding request to an interactive voice response device, wherein the account binding request is a request for binding a user account to the terminal device to enable the interactive voice response device to record information about the binding between the user account and the terminal device;
a forwarding setting unit configured to bind configuration information for missed call forwarding of the user account onto a preset service number of the interactive voice response device;
a missed call receiving unit configured to receive a missed call reminder sent by the interactive voice response device according to the information about the binding, wherein the missed call reminder is a reminder of a missed call to the user account, wherein the interactive voice response device comprises an account mapping unit configured to record information about binding between a user account and a terminal device, and further configured to obtain, according to the information about the binding, a terminal device identifier bound to a called user account; and
a message sending unit configured to send call information as a missed call reminder to a terminal device corresponding to the terminal device identifier.

12. The missed call reminding system according to claim 11, wherein the service server comprises a short message gateway, an instant messaging server, and a push server.

13. A missed call reminding method, comprising:
sending, by a terminal device, an account binding request to an interactive voice response device, wherein the account binding request is a request for binding a user account to the terminal device to enable the interactive voice response device to record information about the binding between the user account and the terminal device;
binding, by the terminal device, configuration information for missed call forwarding of the user account onto a preset service number of the interactive voice response device; and
receiving, by the terminal device, a missed call reminder sent by the interactive voice response device according to the information about the binding, wherein the missed call reminder is a reminder of a missed call to the user account.

14. The missed call reminding method according to claim 13, wherein the information about the binding between the user account and the terminal device comprises mapping relationships between all user accounts that use the terminal device and a terminal device identifier, and wherein receiving, by the terminal device, the missed call reminder sent by the interactive voice response device according to the information about the binding, wherein the missed call reminder is the reminder of the missed call to the user account, specifically comprises receiving missed call reminders that are sent by the interactive voice response device to other user accounts except the called user account in the terminal device by using a short message gateway.

15. The missed call reminding method according to claim 13, wherein the information about the binding between the user account and the terminal device further comprises at least either of a mapping relationship between the terminal device identifier and an instant messaging application and a mapping relationship between the terminal device identifier and a push service, wherein receiving, by the terminal device, the missed call reminder sent by the interactive voice response device according to the information about the binding, wherein the missed call reminder is the reminder of the missed call to the user account, specifically comprises receiving, by an instant messaging application in the terminal device, a missed call reminder that is sent by the interactive voice response device to the terminal device by using an instant messaging server, or wherein receiving, by the terminal device, the missed call reminder sent by the interactive voice response device according to the information about the binding, wherein the missed call reminder is the reminder of the missed call to the user account, specifically comprises receiving, by a push application in the terminal device, a missed call reminder that is sent by the interactive voice response device to the terminal device by using a push server.

16. The missed call reminding method according to claim 13, wherein the terminal device binds the configuration information for missed call forwarding of the called user account onto a preset service number of the interactive voice response device by dialing a specific service of an operator.

17. A missed call reminding method, comprising:
recording, by an interactive voice response device, information about binding between a user account and a terminal device, and obtaining, according to the information about the binding, a terminal device identifier bound to a called user account; and
sending, by the interactive voice response device, call information as a missed call reminder to a terminal device corresponding to the terminal device identifier.

18. The missed call reminding method according to claim 17, wherein the information about the binding between the user account and the terminal device comprises mapping relationships between all user accounts that use the terminal device and the terminal device identifier, wherein sending, by the interactive voice response device, the call information as the missed call reminder to the terminal device corresponding to the terminal device identifier, specifically comprises using a short message gateway to send the call information to other user accounts bound to the terminal device except the called account in the terminal device.

19. The missed call reminding method according to claim 17, wherein the information about the binding between the user account and the terminal device further comprises at least either of a mapping relationship between the terminal device and an instant messaging application and a mapping relationship between the terminal device and a push service, wherein sending, by the interactive voice response device, the call information as the missed call reminder to the terminal device corresponding to the terminal device identifier, specifically comprises using an instant messaging server to send the call information to an instant messaging application in the terminal device, or wherein sending, by the interactive voice response device, the call information as the missed call reminder to the terminal device corresponding to the terminal device identifier, specifically comprises using a push server to send the call information to a push application in the terminal device.

20. The missed call reminding method according to claim 17, wherein before sending, by the interactive voice response device, the call information as the missed call reminder to the terminal device bound to the called user account, the method further comprises:
recording a voice message that is left in time of calling, and converting the voice message into text information; and
in time of sending, sending at least either of the voice message and the text information together with the call information as a missed call reminder to the terminal device bound to the called user account.
